(19) United States
(12) Patent Application Publication
(10) Pub. No.: US 2016/0102877 A1
(43) Pub. Date: Apr. 14, 2016

(54) SYSTEM AND METHOD FOR MONITORING AND CONTROLLING HEATING, VENTILATING, AND AIR CONDITIONING EQUIPMENT

(71) Applicant: CAPTIVE-AIRE SYSTEMS, INC., Raleigh, NC (US)

(72) Inventors: William Brian Griffin, Columbia, PA (US); William Earle Glaub, Raleigh, NC (US); John Daniel Zoltowski, Lancaster, PA (US); Brady Jay Ambrose, Hurricane, UT (US); Richard Quackenbush, Raleigh, NC (US)

(73) Assignee: CAPTIVE-AIRE SYSTEMS, INC., Raleigh, NC (US)

(21) Appl. No.: 14/512,730

(22) Filed: Oct. 13, 2014

(51) Int. Cl. F24F 11/00; G05B 15/02

(52) U.S. Cl. CPC F24F 11/006; G05B 15/02

(57) ABSTRACT

A system and process is provided for remotely monitoring and controlling an HVAC system. Data and information relating to an HVAC unit is transmitted from the HVAC unit via the internet to a remote server. The server is programmed to detect and diagnose problems with the HVAC unit and to respond by sending command signals to the HVAC unit that address the problems or modifies the operation of the HVAC unit.

### FIELD OF THE INVENTION

The present invention relates to heating, ventilating and air conditioning equipment and more particularly to control systems therefor.

### BACKGROUND OF THE INVENTION

Managing and controlling HVAC systems—which include conventional heating and air conditioning systems or HVAC systems forming a part of an air make-up system for a commercial kitchen—is expensive. A number of factors contribute to the expense. One factor is that many HVAC systems are not continuously monitored. In many cases, HVAC systems are maintained through periodic inspection and maintenance programs. While this is better than ignoring the HVAC system until there is a failure, there are shortcomings and drawbacks to simply relying on a periodic inspection and maintenance program. Periodic maintenance does not always detect serious problems or discover abnormalities in the HVAC unit's operation that is likely to lead to more severe problems in the future that, if left uncorrected, will be even more expensive to repair. Secondly, simply the logistics and labor required in connection with service calls is relatively expensive and inefficient.

There has been and continues to be a need for a system and process for continuously monitoring and controlling HVAC systems without relying on periodic inspection and maintenance programs and wherein corrective action can be directed without requiring a service call.

### SUMMARY OF THE INVENTION

The present invention relates to a system and process for remotely monitoring and controlling an HVAC system. Data and information relating to an HVAC unit is transmitted from the HVAC unit via the internet to a remote server site. One or more servers at the remote server site receive the data and information. The servers are programmed to detect and diagnose problems with the HVAC unit and to respond by sending command signals to the HVAC unit that addresses problems or inefficiencies with the HVAC unit.

In one embodiment, the present invention relates to a method of remotely monitoring and controlling an HVAC system. This method entails receiving by one or more remote servers located on a remote service site data and information sent from an on-site HVAC unit through an interface board operatively connected to the on-site HVAC unit and through the internet. Based on this data and information received by the remote servers, the method entails detecting and diagnosing problems and general operating conditions of the HVAC unit. The method entails interrupting commands being sent by an on-site thermostat to the on-site HVAC unit where the commands sent by the thermostat are sent through the interface board operatively connected to the HVAC unit. Once commands from the thermostat have been interrupted, the method entails directing corrective commands from the remote servers via the internet and through the interface board to the HVAC unit and modifying the operation of the HVAC unit.

In another embodiment of the present invention, there is provided an HVAC system including a local and remote monitoring and control system. The HVAC unit is located on a site for heating and cooling a conditioned space also located on the site. There is provided a system for locally and remotely monitoring and controlling the HVAC unit. This system includes an interface board connected to the HVAC unit. A thermostat is operatively connected to the interface board for sensing the temperature in the conditioned space and sending command signals via the interface board to the HVAC unit for controlling the same. There is also provided a local user interface device that is locally located and operatively connected to the interface board for enabling a user to interact with the interface board. There is also a communications module connected to the interface board and configured to enable communications to one or more remote devices via the internet. There is a remote server site that includes one or more remote servers having a main computer program and configured to interact via the internet with the communications module. In particular, the one or more servers are operative to acquire data and information relating to the HVAC unit via the interface board, communications module and the internet. Based on this data and information, the one or more remote servers are operative to detect and diagnose problems with the HVAC unit. In addition, the one or more servers are operative to issue commands that include a command that overrides the thermostat and enables the one or more servers to communicate directly with the HVAC unit via the interface board without interference from the thermostat.

Other objects and advantages of the present invention will become apparent and obvious from a study of the following description and the accompanying drawings which are merely illustrative of such invention

### BRIEF DESCRIPTION OF DRAWINGS

FIG. 1 is a schematic representation of the system for controlling heating ventilating, and air conditioning equipment.

FIG. 2 is a schematic layout of components of the system for monitoring and controlling heating, ventilating, and air conditioning equipment.

FIG. 3 is a logic diagram of logic implemented in one embodiment of a server-side program.

### DESCRIPTION OF THE INVENTION

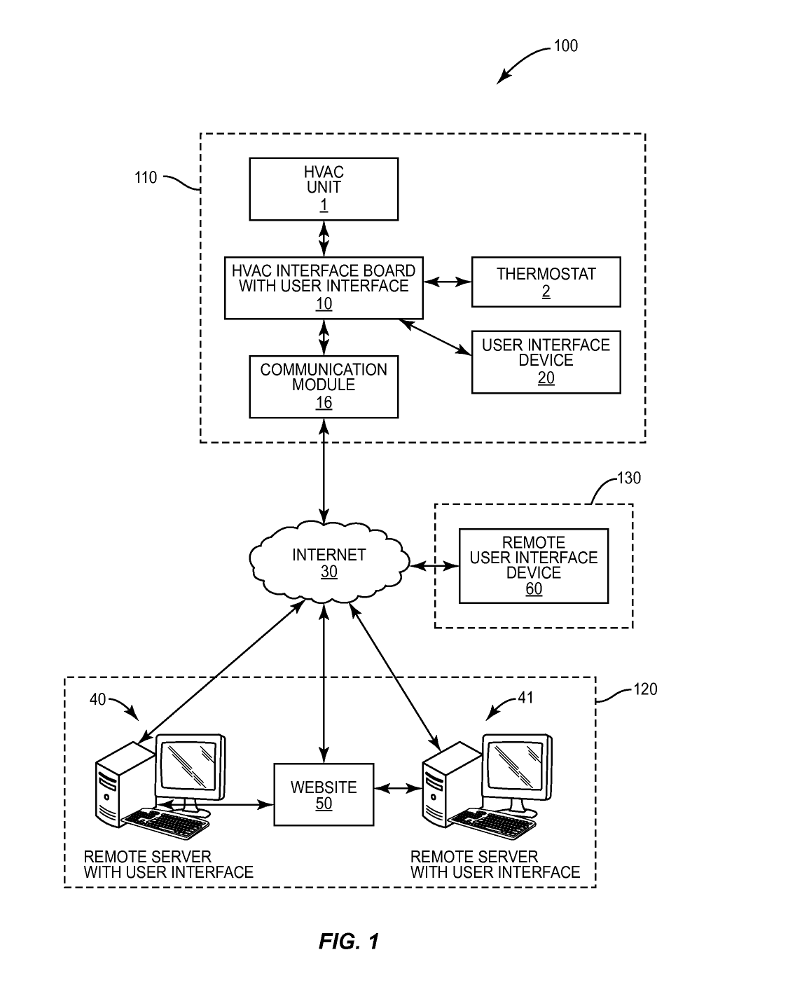

Heating, ventilating, and air-conditioning (HVAC) equipment is an important component of structures, especially those for housing personnel as well as other things for which the thermal environment is important for safety, comfort, and usability. Illustrated generally by the numeral 100, the system of the present invention is illustrated in FIG. 1 along with a monitored and controlled HVAC unit 1 located at a site of interest, or local site 110. HVAC unit 1 may comprise one or more of a heating system or furnace and a cooling system or air conditioner. Further, HVAC unit 1 may comprise a combined heating and cooling system such as a heat pump. Operation of HVAC unit 1 serves to assure desired environmental conditions, temperature, and in some cases, humidity, of a conditioned space generally comprising one or more room of a building or structure.

As discussed in detail below, HVAC unit 1 may include heating and cooling components for heating and cooling air circulated through the HVAC unit and a conditioned space, such as a building or room. HVAC unit 1 also includes an air handling system comprising one or more blowers and dampers for receiving air returned from the conditioned space, as well as possibly outside air, and for directing the air to the heating and cooling components and then to the conditioned space.

Monitoring and control system 100 of the present invention provides for monitoring and controlling HVAC unit 1 locally and remotely. Portions of system 100 for local monitoring and control includes components and methods deployed in the vicinity of HVAC unit 1, or at local site 110. The system for remote monitoring and controlling the HVAC unit 1 also includes components and methods deployed at one or more sites significantly distant from local site 110, such as remote sites 120, 130. Generally, similar monitoring and control functions may be exercised from local site 100 as well as from the remote sites such as sites 120, and 130.

Considering first the components deployed at local site 110, these components include an interface board 10, which is operatively connected the HVAC unit 1 and which may be installed therein as shown in FIG. 1. Further included may be a space thermostat 2 disposed in the conditioned space 3 or configured to sense environmental conditions in the conditioned space. Thermostat 2 is operatively connected to interface board 10, and, through the interface board to HVAC unit 1. Thermostat 2 may be of any of a number of well-known configurations that include sensors for sensing the temperature in the conditioned space as well as, in some embodiments, sensors for sensing relative humidity in the conditioned space. Further, thermostat 2, includes well-known means for storing a schedule of desired space temperatures along with well-known means of comparing sensed space temperature continuously, comparing the sensed temperature to the scheduled or desired temperature at a particular time, and sending a command to HVAC unit 1 as needed to correct any difference between sensed temperature and the temperature scheduled for the time. As those skilled in the art in HVAC operations appreciate, thermostat 2 may also include relative humidity sensing capability, along with a humidity schedule storage capacity and means of comparing sensed humidity of the air in the conditioned space and commanding HVAC unit 1 as needed to correct errors between sensed humidity and desired humidity. It is appreciated that in terms of the normal functioning of thermostat 2, interface 10 serves only to pass control commands through from the thermostat to HVAC unit 1. Other functions of interface 10 are discussed below.

Turning now more particularly to interface board 10, it is appreciated that the interface board may be configured as a printed circuit board whereupon are mounted various electrical and electronic components of known design. These components may be selected and interconnected as one of skill in data acquisition and control would do to enable monitoring and control actions as discussed below. For example, interface board 10 includes a thermostat connection strip, or collection of terminals for connecting standard thermostats such as thermostat 2 to the interface board. Interface board 10 may include a human interface for enabling a human operator positioned at the board to selectively view the values of various operating variables, such as conditioned space temperature and humidity. The human interface includes an onboard display, which in one embodiment may be an LCD, and a plurality of buttons operable for use by the human operator to select variables for viewing and to, in some cases, modify operating parameters such as temperature set points.

Interface board 10 further includes a connection for connecting to a local user interface device 20 at the local site but disposed away from the interface board to enable a similarly-disposed human operator to interact with the interface board. User interface 20 may be a computer monitor, microcomputer, or a hand held computing or communications device such as a tablet or smart phone. Connection between interface board 10 and user interface device 20 may be, for example, by hard wire, such as RJ45 Ethernet, or by near field wireless connection such as Bluetooth. A human operator is enabled to selectively view HVAC operating variables and, in appropriate cases, make changes in operating conditions.

Interface board 10 includes a connection or port for connecting to a communications module or board 16 that is conventionally configured to enable remote connections by way of the Internet 30 to other devices. Through the well-known communications capabilities of the Internet 30, communications, which may be two-way, are enabled with any number of remote sites such as remote sites 120 and 130.

Remote site 120 is a server site where one or more servers 40, 41 are disposed. Servers 40, 41 comprise computers having a main program running thereon and configured to interact by way of the Internet 30 with communications board 16. Through communications module 16 and interface board 10, servers 40, 41 acquire data from the HVAC unit 1 via interface board. Utilizing these data and under the control of a main program, the servers detect and diagnose problems with the HVAC unit 1 and associated components. Likewise under the control of the main program, servers 40, 41 may issue commands to interface board 10 for controlling HVAC unit 1, including commands for modifying the operation thereof. Moreover, servers 40, 41 may, through conventional means, provide human interface for one or more direct human operators, such as a direct operator. Direct operators may interact with HVAC unit 1 in a manner similar to the interactions for which local operators are enabled by system 100, which includes intervening in the operation of HVAC unit 1 in order to diagnose problems with the HVAC unit and associated systems as well as to initiate modifications in the operation thereof.

Additionally, under the influence of the main program, sometimes called the server-side program, historical data regarding the operation of HVAC unit 1 may be periodically and regularly collected and stored in memory or in a database associated with servers 40, 41. Such historical information may include data acquired over time comprising actual conditioned space environment in terms of, for example, temperature and humidity, set point schedules for conditioned space environment, external weather data, airflow characteristics including, for example, pressures and possibly flow rates in the various ducts conducting air within the system, and occupancy data. Further, the historical data may include derived data indicating occurrences of various faults and out-of-desired-range variables. These historical data may be accessible by the server-side program in diagnosing problems and in developing control or modification commands. These historical data may be accessible by human operators engaged in developing strategic design modifications for system 100 and the associated hardware system 200 and in designing and developing new such systems.

Remote site 120 may also include a website 50 residing on a web server, which may be one of servers 40, 41, or another computer server interfaced with the Internet 30. Through website 50, a remote user may monitor and control HVAC unit 1. Furthermore, a user may access data stored on servers 40, 41. Remote user may have access to the Internet 30 via a device 60 such as a computer, tablet, smart phone, or the like that is equipped for internet access.

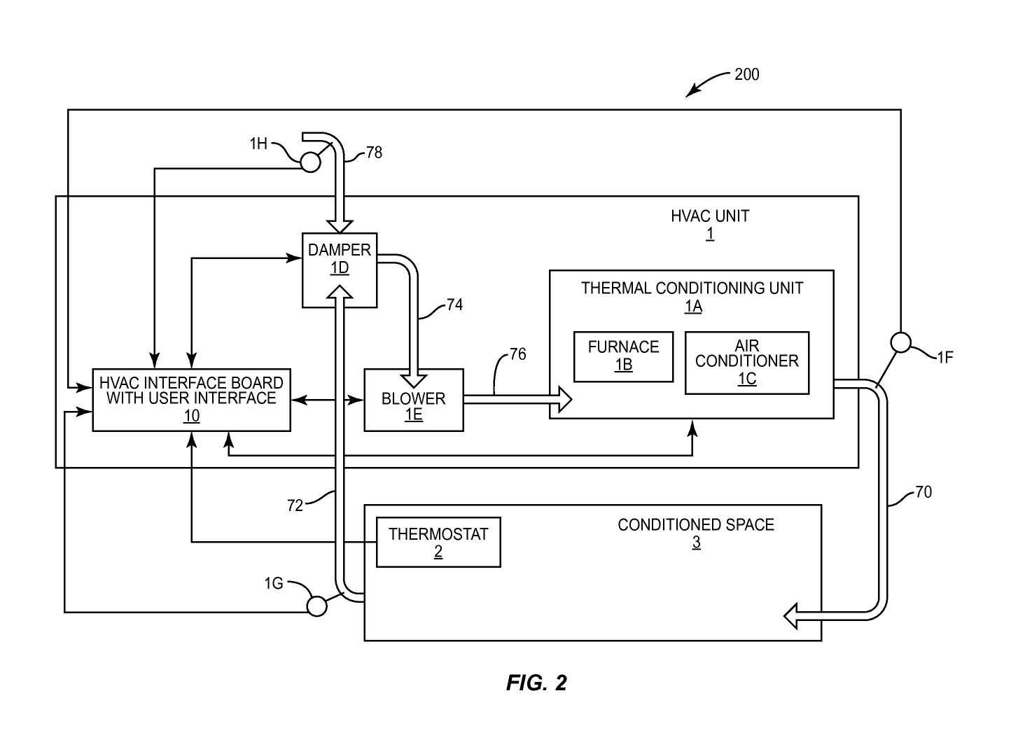

Turning now to consideration of a hardware embodiment, with particular reference to FIG. 2, it is seen that the hardware system 200 comprises HVAC unit 1, as described above, installed so as to provide conditioned air for a space 3, otherwise referred to as the conditioned space. HVAC unit 1 may, for example, be configured as a roof top unit disposed on the roof of a building. Space 3 may comprise one or more rooms situated within the building. For example, space 3 may be a restaurant, including dining and food preparation rooms. Space 3 may be configured with a system of ducts and registers of well-known design and supplied with conditioned air from HVAC unit 1 by means of supply duct 70. Air is returned from space 3 to HVAC unit 1 by means of return duct 72. Disposed within space 3 is thermostat 2, described above, for sensing environmental conditions of the space, such as temperature and humidity. Thermostat 2 is operatively connected to HVAC unit 1, which is configured as explained more fully below to condition air to be supplied via duct 70 to space 3.

Also included in hardware system 200 are a series of environmental sensor assemblies or modules 1F, 1G, and 1H. Each module or assembly may comprise one or more temperature sensors, humidity sensors, air pressure sensors, or air flow velocity sensors. The sensors of each module may be connected to interface board 10, and values sensed by each such sensor may be received by the interface board and transmitted via the Internet 30 to servers 40 and 41.

HVAC unit 1, as discussed above, may be one of any of a number of well-known types of heating and cooling equipment. In one embodiment, illustrated in FIG. 2, HVAC 1 includes a thermal conditioning unit 1A, which may comprise a furnace 1B and an air cooler such as an air conditioner 1C. Unit 1A comprises well-known heat transfer components to transfer heat between the unit and air supplied to the unit via duct 76. Further included in HVAC unit 1 is an air handling system comprising a damper 1D and a blower 1E. Damper 1D is configured to receive return air from space 3 via duct 72 as well as outside, or fresh, air via duct 78. As discussed further below, damper 1D, provides, under the various modes of control discussed above, for proportioning return and fresh air as required to maintain, for example, needed environmental conditions within space 3. For example, in the case of rising humidity in space 3, and when outside air humidity is acceptable, fresh air may be admitted to reduce the humidity of the air circulating in the space. Blower 1E is configured to deliver air from damper 1D via duct 74 to unit 1A. Blower 1E may be a fixed flow rate blower or a variable flow rate blower, each of well known design.

It is appreciated that units 1A, 1D, and 1E are conventionally controlled by thermostat 2, in which, schedules of desired space temperature and perhaps humidity set points may be programmed. Conventional thermostat 2 may include capability to sense instantaneous temperature and perhaps humidity in space 3, compare the sensed data with scheduled, or set point, values, and provide appropriate signals or commands to the above-described components of HVAC unit 1. In the present system, however, interface board 10 may be installed in HVAC unit 1 as discussed above. Interface board 10 may be communicatively connected with thermostat 2 and units 1A, 1B, 1C, 1D, and 1E such that signals or commands from the thermostat reach said units only from interface board 10. Such interconnection provides for, in a first mode, the command signals from thermostat 2 to be sensed by interface board 10, and the sensed data passed through to units 1A, 1B, 1C, 1D, and 1E just as if the interface board were not installed. In this mode, interface board 10 functions to transmit the sensed signals as data to servers 40, 41, as described above.

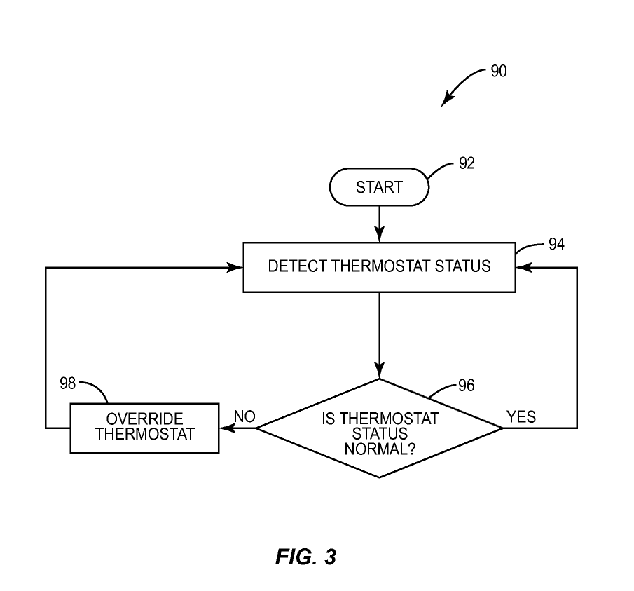

In a second mode, interface board 10 may interrupt transmission of signals and commands from thermostat 2, and, in place of the signals and commands from the thermostat, send alternative signals or commands generated to units 1A, 1B, 1C, 1D, and 1E. The second mode may be initiated in various ways and for various reasons. For example, a remote operator may intervene to perhaps test the system 100 by requiring the system to follow, for a period of time, a schedule different from a schedule programmed into thermostat 2. This kind of instantiation of the second mode may be useful in diagnosing certain irregularities in the functioning of HVAC unit 1 that have been observed by or reported to a remote operator. The second mode may also be automatically initiated under control of the server-side program when this program detects operational malfunctions or faults in the operation of HVAC unit 1 and associated components of hardware system 200. For example, faults in sensing or control actions of thermostat 2 may be detected. In the case of thermostat malfunction, for example, the second mode may be implemented by the server-side program using an exemplary logic control 90 as depicted in FIG. 3. In the course of regular and periodic monitoring of thermostat status, the remote server-side program branches to logic portion 90 at block 92. Detecting the status of the thermostat, block 94, leads to a comparison with stored parameters, block 96, which results in a determination as to whether the status is normal or not. For example, among the factors the server-side program may check is whether there is a temperature signal issuing from thermostat 2, the absence of which would be deemed a fault. In this example, control would branch from block 96 to block 98. Block 98 represents the issuance from the server-side program of a command to interface board 10 to effectively disconnect thermostat 2 from the components of HVAC unit 1 and initiate alternative thermostatic control of the HVAC unit utilizing remote server-side logic (servers 40, 41) and schedules loaded by the server-side program into the interface board 10. Under such conditions, it is appreciated that environmental data used by the server-side thermostatic function may come from return sensor assembly 1G.

It is appreciated, then, that by means of system 100, users proximate to HVAC unit 1, as well as remote users have access to the HVAC unit 1 to monitor its operation and to interact with the HVAC unit to modify its operation in various ways. Communication links between remote users and HVAC unit 1 are implemented via the Internet 30 using well-known internet communications protocols. Remote users may, from anywhere, interact with HVAC 1 as well as servers 40, 41 using generally any user device configured to access the Internet 30. Remote users' access is controlled by standard internet login and authentication protocols, and authenticated remote users may be enabled to exercise direct control of HVAC unit 1, including overriding thermostat 2. Additionally, under the control of the main, or server-side, program, thermostat 2, may be automatically overridden upon, for example, a determination of thermostat malfunction or other system malfunction by logic implemented in the server-side program. In the case of thermostat 2 being overridden automatically under program control, the functions of the thermostat may be undertaken by server-side program in cooperation with interface board 10. System 100, thus provides for continuous data monitoring of HVAC unit 1 as well as interventional control of the HVAC unit by human operators situated either locally or remotely. Further, interventional control of HVAC unit 1 may be by automatic action of the server-side program.

The specification refers to terms such as “on-site”, “local”, “locally”, “remote”, and “remotely”. The terms “on-site” and “local” refer to the location of HVAC unit 1, space 3 and the thermostat 2, as well as other devices such as user interface devices that are located on the same site as the HVAC unit and the conditioned space. This is to be contrasted with the terms “remote” and “remotely”. Servers and the devices that are located remotely are not located on-site or locally. Servers and devices remotely located and referred to as being “remote” are located substantial distances from the HVAC unit and, in some cases, can be as far away as hundreds or even thousands of miles.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

What is claimed is:

1. An HVAC system including a local and remote monitoring and control system, comprising:
A. an HVAC unit located on a site for heating or cooling a conditioned space located on the site;
B. a system for locally and remotely monitoring and controlling the HVAC unit including:
i. an interface board connected to the HVAC unit and wherein both the HVAC unit and the interface board are located on the site;
ii. a thermostat operatively connected to the interface board for sensing the temperature in the conditioned space and wherein, in a normal mode of operation, the interface board passes control commands from the thermostat through the interface board to the HVAC unit;
iii. an on-board display associated with the interface board for displaying selected system variables and including a user interface that enables a user to input commands into the interface board;
iv. a local user interface device locally located and operatively connected to the interface board for enabling a user to interact with the interface board;
v. a communications module connected to the interface board and configured to enable communications to one or more remote devices via the internet;
vi. a remote server site having one or more remote servers having a main computer program and configured to interact via the internet with the communications module; and
vii. wherein the one or more remote servers:
a. acquire data and information relating to the HVAC unit via the interface board, the communication module and through the internet;
b. detect and diagnose problems with the HVAC unit based on the data and information acquired; and
c. issue commands that include a command that preempts the thermostat from issuing commands to the HVAC unit via the interface board and further issues commands for modifying the operation of the HVAC unit.

2. A method of remotely monitoring and controlling an HVAC system, comprising:
receiving, by one or more remote servers located on a remote server site, data and information sent from an on-site HVAC unit through an interface board operatively connected to the on-site HVAC unit and through the internet;
based on the data and information received by the one or more remote servers, detecting and diagnosing problems or operating conditions of the HVAC unit;
interrupting commands being sent by an on-site thermostat to the on-site HVAC unit where the commands are sent by the thermostat through the interface board operatively connected to the HVAC unit; and
directing corrective commands from the one or more remote servers via the internet and through the interface board to the HVAC unit and modifying the operation of the HVAC unit.

3. The HVAC system of claim 1 wherein the HVAC system is operated in first and second modes;
wherein in the first mode, the HVAC unit is controlled by the thermostat without any input from the one or more remote servers; and
wherein in the second mode, the remote servers override the thermostat and the HVAC unit is controlled by one or more of the remote servers without any input from the thermostat.
